(19) United States
(12) Patent Application Publication
(10) Pub. No.: US 2005/0172017 A1
(43) Pub. Date: Aug. 4, 2005

(54) Policy engine

(76) Inventor: Devon L. Dawson, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/770,780

(22) Filed: Feb. 3, 2004

(51) Int. Cl. G06F 15/173; G06F 15/177

(52) U.S. Cl. 709/223; 709/220

(57) ABSTRACT

Policy engine methods, systems, and devices are provided. One method of updating a policy engine of a computing device includes receiving an update string including a policy component, extracting the policy component from the update string, and associating the policy component with a logical framework stored in memory.

Policy engines are executable instructions used by a computing device to control the operation of the device. Policy engines use a number of instruction sets called policies to provide the control of the devices. Each policy contains a number of rule statements that are made up of a set of logical statements. These logical statements provide a logical framework for the rule statement and determine how the device should respond to the occurrence of a particular event.

For example, one type of logical statement is an if-then statement, as such statements are known to those skilled in the art. In a logical statement, a condition is presented and if met, an action is performed. (i.e., If [condition], then [action]).

The logical framework can be viewed as the format of the rule. The logical framework is the positioning of the different components within the logical statement. For example, the logical framework of the if-then statement above is the positioning of logical components IF and THEN and the positioning of the policy components “condition” and “action”.

A rule statement uses the logical framework and particular policy components to control a function of a device. For example, a rule statement is: If [the network usage is high], then [disable high risk servers]. In this if-then statement, the condition (in the first set of brackets) is met when network usage is high and the action (in the second set of brackets), to disable high risk servers, is initiated when the condition has been met.

Rules can be used to control various actions within the computing device as those skilled in the art will understand. For example, rule statements can be used to: detect network connections; allocate data, processor, or memory resources; or direct information or data from the computing device to another device, such as a computing device or peripheral device, to name a few.

As indicated above, a policy contains one or more rules which are used in various ways such that the policy engine can use a number of rules to perform actions based upon a number of conditions. The rules within a policy can be organized in series or in parallel.

In a series structure, the result of one rule feeds into another rule. For example, if the condition is met, an action occurs, and if an action occurs another condition is met and another action occurs.

For instance, the policy can include two if-then statements, such as if A occurs, then perform B, and if B occurs, then perform C. In such a case, when condition A is met, then action B is performed. However, in this second example, if A is not met, no action is taken. And, when condition A is met, B is performed and since the performance of B is the condition to be met in the second rule of the policy, C is also performed. These rule statements have been organized in serial such that the action or result of one rule is based upon another.

Further, a policy can be created in which an action will be taken regardless of the outcome of an event. For example, the performance or non-performance of an action or the satisfaction or non-satisfaction of a condition, can be a condition for a second rule.

For instance, a policy can include two if-then statements, such as if A occurs, then perform B, and if A does not occur, then perform C. These rule statements have been organized in parallel since the action of one statement does not effect the other statement.

Those skilled in the art will understand that rules can be used for simple and/or complex tasks. For example, rules can be used to do simple tasks such as retrieving a document from storage, extracting information from a document, performing mathematical routines, such as adding or subtracting, formatting information into a print job, or sending a print job to a printing device.

Policies can combine a number of rules to accomplish more complex tasks. For example, policies can be used for tasks containing a number of different actions. Each action could be performed based upon a rule. For example, an exemplary mathematical function can have an addition, subtract, and multiplication component with each component using a rule or a number of rules to perform the operation.

For instance, there can be a rule stating that, given two quantities, add the two together to create a product. Additionally, a rule can be provided that states when to initiate a particular component, such as if multiplication has been done, then perform the addition function.

Policies can also perform a number of the above different tasks, such as retrieving a document from storage, extracting numbers from the document, doing a mathematical calculation on the numbers, formatting the calculated data into a print job, and sending the print job to a printing device for printing.

In some systems, policy engines are provided in a database wherein the rules making up the different policies are grouped together and listed individually. In such cases, there may be duplicate rules in several policies within the policy engine. Additionally, when the policies are updated, entire new rule statements are added. These entire rule statements are then used to replace a rule statement in memory that is to be updated.

In such systems there exists a large amount of duplicate information which takes up valuable memory and can consume processing power in attempting to locate a policy or rule within the database. The use of entire rule statements for updating the system can make the updating of a policy engine time consuming.

### BRIEF DESCRIPTION OF THE DRAWINGS

FIG. 1 is an example of a network environment.

FIG. 2A is an example of a policy definition.

FIG. 2B is and example of association of policy and logical components to instruction routines.

FIG. 3 illustrates a method embodiment of updating a policy engine of a computing device.

FIG. 4 illustrates a method of implementing a policy engine of a computing device.

### DETAILED DESCRIPTION

Embodiments of the present invention provide methods, systems, and devices for use with respect to implementing and updating policy engines. Embodiments of the present invention use a number of policy components and logical statements stored in memory to construct the various policies and thereby reduce the amount of memory and processing time used by the policy engine.

In such embodiments, the policies can be created by using a logical framework, a number of policy components, and location placement information regarding where the policy components are to be positioned in the logical framework. In this way, a logical framework can be used in creating a number of rules based upon the selection and positioning of policy components within the logical framework. Such embodiments also allow rules and policies to be formed at run-time which reduces the amount of storage used to hold the policies and rules.

As stated above, policies can be used to control functions within a device or can be used to control functions that occur between devices within a network. Accordingly, the embodiments described herein can be used with individual devices or on devices within networks.

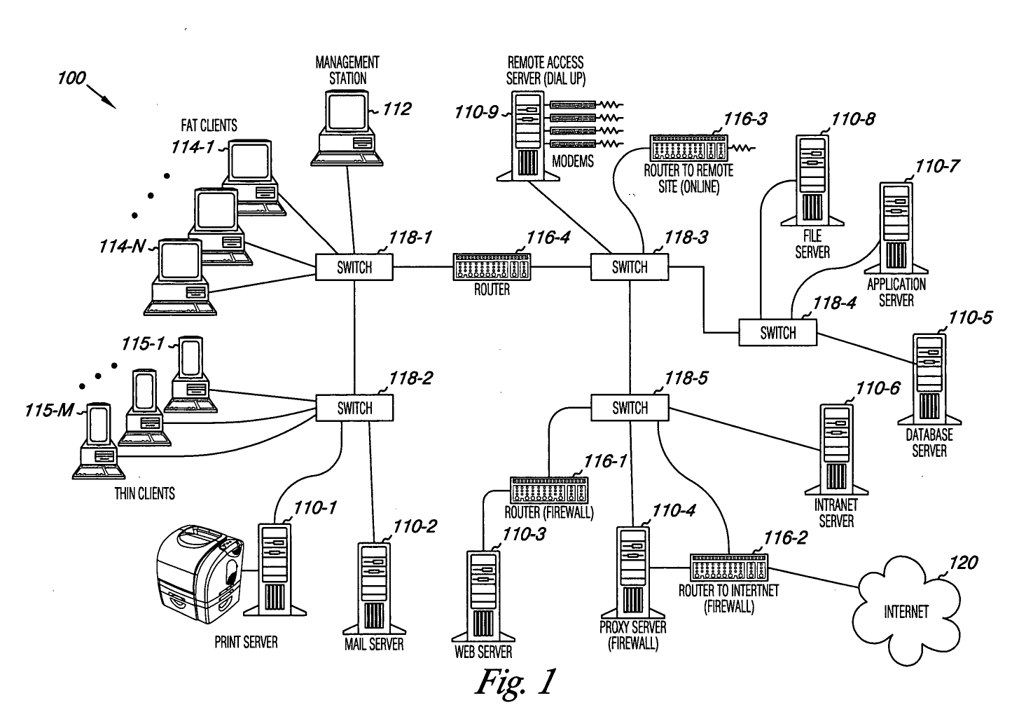

FIG. 1 is an example of a network environment 100. As shown in FIG. 1, a number of devices can be networked together via hardware components such as routers, hubs, switches, and the like. The embodiment of FIG. 1 illustrates computing devices including a network management server in a LAN. However, embodiments of the invention are not so limited.

The embodiment of FIG. 1 illustrates a network 100 having a number of servers 110-1 through 110-9, a management server 112, a number of client devices 114-1 through 114-N and 115-1 through 115-M, a number of routers 116-1 through 116-3, a number of switches 118-1 through 118-5, and a number of other devices, such as printing devices and modems connected through the network 100. The network 100 also includes a link via a router 116-2 to the Internet 120.

The embodiment of FIG. 1 shows various servers used to manage a number of different functions provided by the LAN. However, in practice several functions can be managed on one device and, for large volumes, multiple devices can work together to manage a particular function to balance the traffic on the network. For example, an enterprise network can include a collection of servers, such as a server farm, cooperating to provide functionality to the network.

FIG. 1 illustrates a print server 110-1, a mail server 110-2, a web server 110-3, a proxy server (firewall) 110-4, a database server 110-5, an intranet server 110-6, an application server 110-7, a file server 110-8, and a remote access server (dial up) 110-9. Servers 110-1 to 110-9 can each be connected to a number of other devices. For example, the print server 110-1, as shown in FIG. 1, is connected to a printing device and remote access server 110-9 is shown connected to a number of modems. Additionally, the servers 110-1 to 110-9, shown in FIG. 1, are each also connected to a number of routing, switching, and computing devices. However, the invention is not limited to the number of connections shown.

The examples provided herein do not provide an exhaustive list of network components, but rather are exemplary of some devices that can be within a network environment. Additionally, the above examples and other such devices can also be used as management stations for management of network functions, such as management of network connectivity, print jobs, storage devices, web access, mail service, remote access, file management, and the like.

As stated above, devices can be added to a network and instructions executed to map the new devices within the network. As the number of devices attached to the network proliferates, so too increases the number of policies and rules on the network. In various devices, as technology changes various policies and rules can be changed or updated to address the changes.

For example, with respect to security of a computing device, a policy can be included with the program instructions originally installed on the device. However, as more is understood about the potential threats to a device or as potential threats change, embodiments of the present invention allow the policy to be updated or additional policies added to change the approach to the security of the device. Additionally, embodiments of the invention, as discussed in more detail below, also allow for the policy to be updated or policies to be added without providing an entirely new policy, but rather by updating the policy components or logical framework.

The embodiment of FIG. 1, illustrates that these exemplary devices, and others can be connected to one another and/or to other networks via routers, 116-1, 116-2, 116-3, and 116-4, and hubs and/or switches 118-1, 118-2, 118-3, 118-4, and 118-5, as the same are know and understood by one of ordinary skill in the art. Embodiments of the invention, however, are not limited to the number and/or quantity of devices shown in FIG. 1. The designators M and N are used to indicate that a number of devices can be attached to the network 100. The number represented by M can be the same or different from the number represented by N.

As one of ordinary skill in the art will appreciate, many of these devices include processor(s) and memory hardware. Computer executable instructions, (e.g., software and/or firmware) reside in memory, such as on a management station or other device, to manage a device feature, and/or manage a network.

Policies can be installed in one or more locations within the distributed network devices. Those skilled in the art will understand that a policy can be included within a set of program instructions, such as within application programs, object oriented program instructions, and/or operating system instructions, among others.

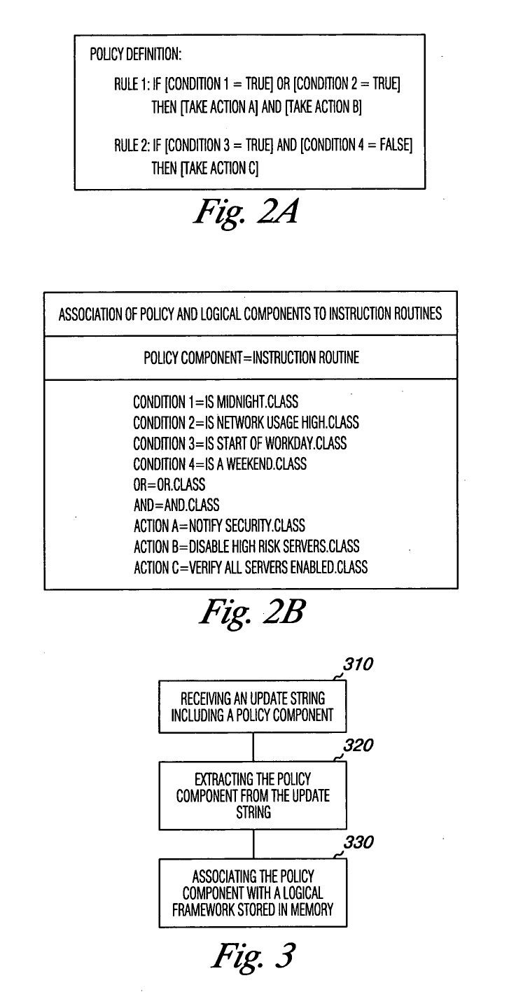

FIGS. 2A and 2B illustrate an example of a policy definition and a number of policy and logical components that are used to form the policy. A “policy” can be a set of one or more rules, where each rule includes one or more conditions (also called antecedents) and actions (also called consequents) and the logical components (e.g., IF, THEN, AND, OR, NOT, etc.) used with the conditions and actions within a logical framework. As stated above, a logical framework is the order or position information for the components that are to be placed in the logical statement. For example, in an If [condition], then [action] logical statement format, the logical framework provides the information as to where the “If” and the other components are to be positioned in relation to each other within the logical statement.

A policy definition is the set of logical statements (i.e., logical framework with a number of logical components positioned therein) that form the policy. For example, in the embodiment shown in FIG. 2A, two logical statements are provided that act together to control functions of a device or network as is described in more detail below.

Those skilled in the art will understand that there are a variety of different types of logical statements that can be used such as: if-then, if-else, and while types, to name a few. The logical statement and/or framework can be stored in memory or provided in firmware independently from the policy components that are to be used for a particular rule. For example, the logical statement If [condition 1] AND [condition 2] can be stored separately from the conditions to be placed in the locations designated for condition 1 and condition 2. Condition 1 for example can be any suitable condition, such as “is midnight”. Likewise, condition 2 can be any suitable condition, such as “is network usage high”.

The actions (e.g., “notify security” and “disable high risk servers”) can also be stored independently from the logical statement. In this way, the same logical statement can be used by a number of different rules by using different conditions and actions within the condition and action spaces provided in the logical statement.

The logical framework can also be stored independently from the logical components such as IF, THEN, AND, OR, WHILE, etc. In this way, the meaning of each of the components can be changed without having to update each and every rule or logical statement using the particular logical component. Such embodiments can also be useful when different policy definitions for a particular logical component are to be used, such as when a rule is to be used in different situations, but a different logical meaning for the rule is desired.

By providing the components independent from the logical framework, a number of rule statements can be created from the same set of logical and policy components.

FIG. 2B is an example of association of policy and logical components to instruction routines. The instruction routines provide the instructions that are initiated to complete a particular part of a rule. For example, the instruction routine for the logical component “AND” will execute to continue reading the logical statement to find other conditions or actions that are to be met or initiated.

In an example, of an instruction routine for a condition component, the condition component “is midnight” can include instructions to request time from the system clock and to determine whether the returned time is midnight. Such a determination can be accomplished, for example, by identifying if the number given by the system for hours is greater than 00:00 (e.g., for military time) or identifying whether the time is 12 a.m. (e.g., for standard time).

In various embodiments, the components and logical framework can be used to form the rule statements that make up a policy. For example, in the exemplary policy definition provided in FIG. 2A, rule 1 of the policy will read: If it is midnight or network usage is high, then notify security and disable high risk servers.

Rule 2 will read: If it is the start of the day and it is not a weekend, then verify that all servers are enabled. In this way, the policy can be used to alert security and take action when certain criteria are met. The policy can also return the system to full server capacity when certain criteria are met.

In various embodiments, each of the components can be updated by providing a different set of instruction routines that are linked to the component. The instruction routines can be maintained in various manners, such as stored in various file formats in memory. For example, FIG. 2B relates to handling class format files, as the same are known and understood by those of ordinary skill in the art.

In the case shown in FIG. 2B, the instruction routines within the class files can be changed. Therefore, when the rule executes instructions to call a class file, the instruction routine can be different and therefore the rule will act differently from a previous use. For instance, with regard to the example, of military time or standard time provided above, the instruction routines can be changed from standard time to military time or vice versa depending on the time information available from the system.

Additionally, the association of the condition can be changed from one instruction routine to another. For example, condition 1 can be changed to associate with “is a weekend.class” instead of “is midnight.class”. In such a case, a change in association, between the condition and an instruction routine, changes the meaning of the rules and the policies in which condition 1 is used.

This update information can be provided in an update string, as the same are known and understood by those of ordinary skill in the art. The update string can include other update information for updating the device in addition to providing policy components, logical components, and/or logical frameworks and can be part of a larger update having other device update information. The updates can be provided to the device in various manners such as on a storage medium, or transmitted to the device over a network (e.g., LAN, WAN, Internet, etc.), to name a few.

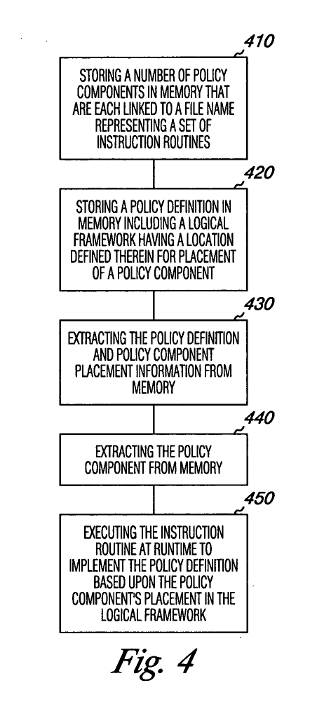

FIGS. 3 and 4 illustrate various method embodiments. As one of ordinary skill in the art will understand, the embodiments can be performed by computer executable instructions operable on the systems and devices shown herein or otherwise. The invention, however, is not limited to a particular operating environment or to software written in a particular programming language. Computer executable instructions, including software, program applications, and/or application modules, suitable for carrying out embodiments of the present invention, can be resident in one or more devices or locations or in several locations in a distributed computing environment.

Unless explicitly stated, the method embodiments described herein are not constrained to a particular order or sequence. Additionally, some of the described method embodiments can occur or be performed at the same point in time.

FIG. 3 illustrates a method embodiment of updating a policy engine. As explained in connection with FIGS. 2A and 2B, program instructions execute to initiate to receive an update string including a policy component, as shown in block 310. As stated above, the update string can include components for policies to control various device and/or network functions, such as for example, management policies, among others.

In block 320, the method embodiment of FIG. 3, includes extracting the policy component from the update string. The update string can include various information for updating the policies and/or policy engine. For example, information such as antecedent and consequent components, logical frameworks, and location placement information can be provided in the update string (e.g., as illustrated in FIGS. 2A and 2B).

Program instructions can be provided, such as on the computing device, which are executable to extract the policy components and other information from the update string. The extracted policy component can then be used to replace and/or add to a policy component stored in memory.

An antecedent component, for example in an if-then type statement, is one that defines a condition to be met. A consequent component is, for example in an if-then type statement, an action that is performed when a condition is met. In such a case, an exemplary rule would be “If [antecedent], then [consequent].

The method embodiment also includes associating the policy component with a logical framework stored in memory at block 330. For example, program instructions can be provided, such as with the update string, which are executable to associate the antecedent and consequent policy components with the logical framework from memory. The method embodiment can also include receiving instructions for using the policy component with the logical framework and a number of other policy components stored in memory.

FIG. 4 illustrates a method embodiment of implementing a policy engine of a computing device. As illustrated with respect to the embodiment of FIGS. 2A and 2B, the method embodiment includes storing a number of policy components in memory that are each linked to a file name representing a set of instruction routines at block 410.

The method embodiment of FIG. 4 also includes storing a policy definition in memory including a logical framework having location placement information for a policy component at block 420. Those skilled in the art will understand that the policy definition can have various logical formats. For example logical formats include, but are not limited to, if-then, if-else, while types logical framework structures.

At block 430, the method embodiment also includes extracting the policy definition and the location placement information from memory. As described above with respect to FIG. 3, program embodiments can execute instructions to extract policy and logical information from a source, such as from memory or an update string.

The method embodiment illustrated in FIG. 4 also includes extracting the policy component from memory at block 440. At block 450, the method embodiment also includes executing an instruction routine at runtime to implement the policy definition based upon the location placement information in the logical framework.

The method embodiment can also include executing a platform independent function call, as the same will be known and understood by those of skill in the art, to extract the location placement information from the update string. In this way, a set of program instructions can be created in a platform independent format, such as Java, and then be used with a variety of platforms.

Although specific embodiments have been illustrated and described herein, those of ordinary skill in the art will appreciate that any arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one.

Combination of the above embodiments, and other embodiments not specifically described herein will be apparent to those of skill in the art upon reviewing the above description. The scope of the various embodiments of the invention includes various other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method of updating a policy engine, comprising:
receiving an update string including a policy component;
extracting the policy component from the update string; and
associating the policy component with a logical framework stored in memory.

2. The method of claim 1, further including receiving instructions for using the policy component with the logical framework and a number of other policy components stored in memory.

3. The method of claim 1, further including program instructions executable to receive an update string including an antecedent policy component and a consequent policy component.

4. The method of claim 3, further including program instructions executable to extract the antecedent and consequent policy components from the update string.

5. The method of claim 4, further including program instructions executable to associate the antecedent and consequent policy components with the logical framework from memory.

6. A method of implementing a policy engine of a computing device, comprising:
storing a number of policy components in a memory that are each linked to a file name representing a set of instruction routines;
storing a policy definition in memory including a logical framework having a location placement information for a policy component;
extracting the policy definition and the location placement information from memory;
extracting the policy component from memory; and
executing an instruction routine at runtime to implement the policy definition based upon the location placement information in the logical framework.

7. The method of claim 6, further including storing a policy definition having an if-then type logical framework.

8. The method of claim 6, further including storing a policy definition having an if-else type logical framework.

9. The method of claim 6, further including storing a policy definition having a while type logical framework.

10. The method of claim 6, further including executing a platform independent function call to extract the location placement information from the update string.

11. The method of claim 10, wherein the platform independent function call is a Java based function call.

12. A computer readable medium having program instructions to cause a device to perform a method, comprising:
receiving an update string including a policy component;
extracting the policy component from the update string; and
associating the policy component with a logical framework stored in memory.

13. The computer readable medium of claim 12, wherein the method further includes receiving an update string including network management policy components.

14. The computer readable medium of claim 12, wherein the method further includes replacing a policy component stored in memory with the extracted policy component.

15. The computer readable medium of claim 12, wherein the method further includes receiving an update string including a logical framework and extracting the logical framework from the update string.

16. A computing device, comprising:
a processor;
memory in communication with the processor having logical frameworks stored thereon that are used to form policies;
program instructions stored in memory and executable on the processor to receive an update string including a policy component; and
means for extracting the policy component from the update string and associating the policy component with a logical framework stored in memory.

17. The computing device of claim 16, wherein the means for extracting the policy component include program instructions which execute identify the policy component within the update string and store the policy component in memory.

18. The computing device of claim 16, wherein the means for associating the policy component with a logical framework include program instructions which execute to identify an association between the policy component and the logical framework and store the association information in memory.

19. The computing device of claim 16, further including program instructions executable to receive an update string including a policy component, a logical framework, and association instructions for associating the policy component with the logical framework.

20. The computing device of claim 19, further including program instructions executable to extract the policy component, logical framework, and association instructions from the update string.

21. The computing device of claim 20, further including program instructions executable to associate the logical framework with a number of policy components from memory.

22. The computing device of claim 16, further including program instructions executable to receive an update string including an antecedent policy component.

23. The computing device of claim 22, further including program instructions executable to extract the antecedent policy component from the update string.

24. The computing device of claim 23, further including program instructions executable to associate the antecedent policy component with a logical framework from memory.

25. A computing device including a policy engine, comprising:
a processor;
memory in communication with the processor; and
program instructions stored in memory and executable on the processor to:
store a number of policy components in memory that are each linked to a file name representing a set of instruction routines;
store a policy definition in memory including a logical framework having a location placement information of a policy component;
extract the policy definition and the location placement information from memory;
extract the policy component from memory; and
execute an instruction routine at runtime to implement the policy definition based upon based upon the location placement information in the logical framework.

26. The computing device of claim 25, further including program instructions executable to extract policy association information including an identifier for a particular policy component to associate with a particular logical framework.

27. The computing device of claim 25, further including program instructions executable to extract policy association information including an identifier for a particular logical framework and a location within the particular logical framework to associate with a policy component.

28. The computing device of claim 25, further including program instructions executable to receive an update string including a policy component.

29. The computing device of claim 28, further including program instructions executable to extract the policy component from the update string.

30. The computing device of claim 29, further including program instructions executable to associate the policy component with a location within a number of logical frameworks from memory.

31. The computing device of claim 29, further including program instructions executable to associate the policy component with a location within two logical frameworks from memory.
